(19) United States
(12) Patent Application Publication
(10) Pub. No.: US 2013/0313976 A1
(43) Pub. Date: Nov. 28, 2013

(54) BRIGHTNESS REGULATION SYSTEM FOR ILLUMINATON DEVICE

(71) Applicant: FIH (HONG KONG) LIMITED, Kowloon (HK)

(72) Inventor: PAO-CHUN LIN, New Taipei (TW)

(73) Assignee: FIH (HONG KONG) LIMITED, Kowloon (HK)

(21) Appl. No.: 13/889,368

(22) Filed: May 8, 2013

(30) Foreign Application Priority Data
May 25, 2012 (CN) 2012101656201

(51) Int. Cl. H05B 33/08

(52) U.S. Cl. CPC H05B 33/0854
USPC 315/152

(57) ABSTRACT

A brightness regulation system includes a plurality of illumination devices, a portable electronic device, and a management device. The portable electronic device detects a brightness value of a local environment. The management device compares the brightness value of the local environment with a predetermined value, and regulates brightness of the illumination device in a preset area where the portable electronic device is located according to the comparison.

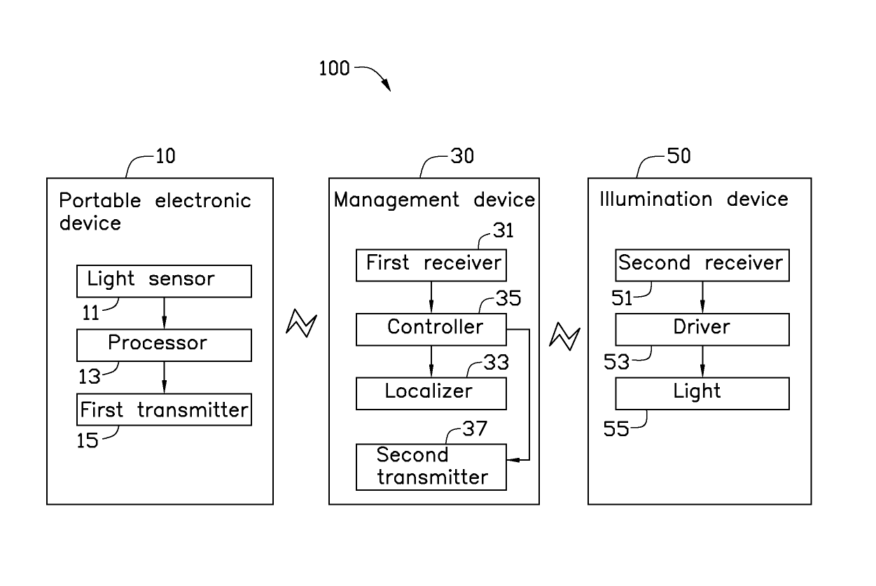

### BACKGROUND

1. Technical Field

The exemplary disclosure generally relates to regulation systems, and particularly to a brightness regulation system for illumination devices.

2. Description of Related Art

Illumination devices, such as home lights, street lights, landscape lights, and billboard lights, are widely used. The illumination devices are usually fully on or fully off. Brightness of the illumination device is non-adjustable. A user can adjust an indoor brightness only by controlling a number of the illumination devices that turns on, which is inconvenient.

Therefore, there is room for improvement within the art.

### BRIEF DESCRIPTION OF THE DRAWINGS

Many aspects of the embodiments can be better understood with reference to the drawings. The components in the drawings are not necessarily drawn to scale, the emphasis instead being placed upon clearly illustrating the principles of the disclosure.

The FIGURE shows a block diagram of an exemplary embodiment of a brightness regulation system.

### DETAILED DESCRIPTION

The FIGURE shows a block diagram of an exemplary embodiment of a brightness regulation system 100. The brightness regulation system 100 includes a portable electronic device 10, a management device 30, and a plurality of illumination devices 50 (only one illumination device 50 is shown in the FIGURE). The portable electronic device 10 detects a brightness of a local environment of the electronic device 10, and transmits a brightness value of the local environment to the management device 30. The management device 30 compares the brightness value of the local environment to a predetermined value, and regulates brightness of the illumination device 50 in a preset area where the portable electronic device 10 is located according to the comparison, until the brightness value of the local environment is equal to the predetermined value.

The portable electronic device 10 can be a mobile phone, a personal digital assistant (PDA), or a tablet computer. The portable electronic device 10 includes a light sensor 11, a processor 13, and a first transmitter 15. The light sensor 11 detects light of the local environment of the portable electronic device 10, and outputs a corresponding analog signal to the processor 13. In the exemplary embodiment, the light sensor 11 detects photons at a 350 nm-1000 nm wavelength in a unit area, and converts the detected photons into a current signal which is then output to the processor 13. The processor 13 is electronically connected to the light sensor 11 and the first transmitter 15. The processor 13 converts the analog signal (that is the current signal) into a digital value, which is the brightness value of the local environment, and outputs the brightness value of the local environment to the first transmitter 15. The first transmitter 15 transmits the brightness value of the local environment to the management device 30. In the exemplary embodiment, the first transmitter 15 transmits the value via a wireless network, such as WIFI network, or BLUETOOTH network for example.

The management device 30 is preferred to be a wireless router, but the disclosure is not limited thereto. The management device 30 includes a first receiver 31, a localizer 33, a controller 35, and a second transmitter 37. The first receiver 31 receives the brightness value of the local environment from the first transmitter 15, and transmits the received value to the controller 35. The localizer 33 detects locations of the portable electronic device 10 and each illumination device 50 via GPS, and transmits the detected locations of the portable electronic device 10 and the illumination devices 50 to the controller 35. The controller 30 is electronically connected to the first receiver 31, the localizer 33, and the second transmitter 37. The controller 35 compares the brightness value of the local environment with the predetermined value, and regulates the illumination device 50 in a preset area where the portable electronic device 10 is located according to the comparison, until the brightness value of the local environment is equal to the predetermined value.

In detail, when the controller 35 receives the brightness value of the local environment, the controller 35 finds out the illumination device 50 in the preset area where the portable electronic device 10 is located according to the locations of the electronic device 10 and the illumination devices 50. The controller 35 compares the brightness value of the local environment with the predetermined value, and if the brightness value of the local environment is greater than the predetermined value, the controller 35 calculates a difference between the brightness value of the local environment and the predetermined value, and outputs control signals corresponding to the difference to the second transmitter 37, the second transmitter 37 transmits the control signal to each illumination device 50 in the preset area, to decrease the brightness of each illumination device 50 in the preset area. If the brightness value of the local environment is less than the predetermined value, the controller 35 calculates a difference between the predetermined value and the brightness value of the local environment, and outputs control signals corresponding to the difference to the second transmitter 37, the second transmitter 37 transmits the control signal to each illumination device 50 in the preset area, to increase the brightness of each illumination device 50 in the preset area. Therefore, the brightness level of the illumination device 50 can be regulated by regulating the predetermined value.

Each illumination device 50 includes a second receiver 51, a driver 53, and a light 55. The driver 53 is electronically connected between the second receiver 51 and the light 55. The driver 53 receives the control signal via the second receiver 51, and regulates a drive current for driving the light 55 according to the control signal, thereby regulating the brightness of the light 55.

The first transmitter 15 can communicate with the first receiver 31 in one of a BLUETOOTH network, a WIFI network, and an Infrared network. The second transmitter 37 can communicate with the second receiver 51 in one of a BLUETOOTH network, a WIFI network, and an Infrared network.

In one embodiment, the preset area is a circle region with the portable electronic device 10 being the center of the circle and having a radius of a preset length (such as 5 meters for example). The illumination devices 50 are located at different locations, such as in different rooms of a house for example. In use, the portable electronic device 10 can be carried by a user. When the user moves, the location of the portable electronic device 10 is changed, and a region of the preset area is changed accordingly, such that the illumination device(s) 50 in the preset area is also changed. Thus, the brightness of the illumination device 50 can be regulated automatically according to the movement of the user and the portable electronic device 10.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A brightness regulation system, comprising:
at least one illumination device;
a portable electronic device detecting a brightness value of a local environment of the portable electronic device; and
a management device comparing the brightness value of the local environment with a predetermined value, and regulating brightness of the at least one illumination device according to the comparison.

2. The brightness regulation system of claim 1, wherein the management device regulates the brightness of the illumination device until the brightness of the illumination device is equal to the predetermined value.

3. The brightness regulation system of claim 1, wherein the portable electronic device comprises a light sensor, a processor, and a first transmitter, the light sensor detects light of the local environment of the portable electronic device, and outputs a analog signal to the processor; the processor converts the analog signal to the brightness value of the local environment, and outputs the brightness value of the local environment to the management device via the first transmitter.

4. The brightness regulation system of claim 3, wherein the light sensor detects photons at a 350 nm-1000 nm wavelength in a unit area, and converts the detected photons to a current signal that is then output to the processor.

5. The brightness regulation system of claim 3, wherein the illumination device regulated by the management device is in a preset area where the electronic device is located.

6. The brightness regulation system of claim 5, wherein the management device comprises a first receiver, a controller, and a second transmitter, the first receiver receives the brightness value of the local environment from the firs transmitter, and transmits the received value to the controller; the controller compares the brightness value of the local environment with the predetermined value, and outputs control signals to the second transmitter according to the comparison; the second transmitter outputs the control signals to the illumination device in the preset area to regulate the brightness of the illumination device in the preset area.

7. The brightness regulation system of claim 6, wherein the management device further comprises a localizer, the localizer detects locations of the portable electronic device and the illumination device, and transmits the detected locations of the portable electronic device and the illumination device to the controller.

8. The brightness regulation system of claim 6, wherein each illumination device comprises a second receiver, a driver, and a light, the driver is electronically connected between the second receiver and the light; the driver receives the control signal via the second receiver, and regulates a drive current for driving the light according to the control signal to regulate the brightness of the light.

9. The brightness regulation system of claim 1, wherein the portable electronic device communicate with the management device in one of a BLUETOOTH network, a WIFI network, and an infrared network.

10. The brightness regulation system of claim 1, wherein the management device is a wireless router.

11. A brightness regulation system, comprising:
a plurality of illumination devices;
a portable electronic device detecting a brightness value of a local environment of the portable electronic device; and
a management device comparing the brightness value of the local environment with a predetermined value, and regulating brightness of the illumination device in a preset area where the portable electronic device is located according to the comparison.

12. The brightness regulation system of claim 11, wherein the management device regulates the brightness of the illumination device until the brightness of the illumination device is equal to the predetermined value.

13. The brightness regulation system of claim 11, wherein the portable electronic device comprises a light sensor, a processor, and a first transmitter, the light sensor detects light of the local environment of the portable electronic device, and outputs a analog signal to the processor; the processor converts the analog signal to a the brightness value of the local environment, and outputs the brightness value of the local environment to the management device via the first transmitter.

14. The brightness regulation system of claim 13, wherein the light sensor detects photons at a 350 nm-1000 nm wavelength in a unit area, and converts the detected photons to a current signal that is then output to the processor.

15. The brightness regulation system of claim 13, wherein the management device comprises a first receiver, a controller, and a second transmitter, the first receiver receives the brightness value of the local environment from the firs transmitter, and transmits the received value to the controller; the controller compares the brightness value of the local environment with the predetermined value, and outputs control signals to the second transmitter according to the comparison; the second transmitter outputs the control signals to the illumination device in the preset area to regulate the brightness of the illumination device in the preset area.

16. The brightness regulation system of claim 15, wherein the management device further comprises a localizer, the localizer detects locations of the portable electronic device and the illumination device, and transmits the detected locations of the portable electronic device and the illumination device to the controller.

17. The brightness regulation system of claim 15, wherein each illumination device comprises a second receiver, a driver, and a light, the driver is electronically connected between the second receiver and the light; the driver receives the control signal via the second receiver, and regulates a drive current for driving the light according to the control signal to regulate the brightness of the light.

18. The brightness regulation system of claim 11, wherein the portable electronic device communicate with the management device in one of a BLUETOOTH network, a WIFI network, and an infrared network.

19. The brightness regulation system of claim 11, wherein the management device is a wireless router.

20. A brightness regulation system for at least one illumination device, the brightness regulation system comprising:
a portable electronic device detecting a brightness value of a local environment of the portable electronic device; and
a management device comparing the brightness value of the local environment with a predetermined value, and regulating brightness of the at least one illumination device according to the comparison.
